(19) United States
(12) Patent Application Publication
(10) Pub. No.: US 2026/0153449 A1
(43) Pub. Date: Jun. 4, 2026

(54) MONITORING APPARATUS AND METHOD

(71) Applicant: ODYSIGHT.AI LTD., Omer (IL)

(72) Inventor: Amir GOVRIN, Ramat Gan (IL)

(21) Appl. No.: 19/404,144

(22) Filed: Dec. 1, 2025

Related U.S. Application Data
(60) Provisional application No. 63/726,696, filed on Dec. 2, 2024.

(51) Int. Cl. G01N 21/88; G01D 21/02; G06T 7/00; G06T 7/20

(52) U.S. Cl. CPC G01N 21/8851; G01D 21/02; G06T 7/0004; G06T 7/20; G06T 2207/10048; G06T 2207/30164

(57) ABSTRACT

A method for monitoring a target utilizes an image capture device capturing images of the target or a part thereof. An indication of the value of a parameter of the target or the environment of the target is received from a non-optical sensor external to the image capture device. A set of settings is determined for the image capture device in accordance with the value of the parameter. An image of the target is then captured by the image capture device using the set of settings.

### CROSS REFERENCE TO RELATED APPLICATION

This Application Claims the Benefit of Priority of U.S. Provisional Patent Application No. 63/726,696, filed Dec. 2, 2024, the contents of which are all incorporated herein by reference in their entirety.

### TECHNICAL FIELD

The present disclosure relates to image capture devices in general, and to a method and apparatus for monitoring using captured images, in particular.

### BACKGROUND

Machine maintenance is a critical part of the operation of any system, plant or facility that uses mechanical or other systems, and is required for lowering the risk of accidents and injuries, minimizing downtime of the system or components thereof, and meeting schedules.

Machine maintenance may include regularly scheduled service visits, routine checks, and scheduled repairs. The maintenance may include replacement, repair, or readjustment of parts that are worn, damaged, misaligned, or the like, or are expected to be so before the next scheduled visit.

However, in addition to the scheduled and routine maintenance activities, constant or periodic monitoring of the target devices, machines or locations may provide for early detection of problems, which may in turn provide for preventive maintenance and identifying emergency situations. Preventive maintenance and timely identification of emergency situations may enable to reduce the frequency of routine maintenance activities, narrow safety margins related to part replacement, or the like.

An important family of monitoring tools comprises imaging devices, designed to capture images of the targets. Imaging devices may include a still images camera, a video camera, a thermal camera, or any other device producing one or more visual representations of the target. By analyzing the images, including analysis of one or more images, and/or comparing sequences of images, problems or anomalies with the target devices may be discovered.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A is a schematic illustration of an exemplary monitoring environment, in accordance with some exemplary embodiments of the disclosure;

FIG. 1B is a schematic illustration of another exemplary monitoring environment, in accordance with some exemplary embodiments of the disclosure;

FIG. 2 is a flowchart of steps in a method for monitoring a target, in accordance with some exemplary embodiments of the disclosure; and

FIG. 3 is a schematic block diagram of a system for monitoring a target, in accordance with some exemplary embodiments of the disclosure.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions and/or electronic circuit. These computer program instructions may be provided to a processor of a general purpose processor, application processor, application specific integrated circuit, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

In the disclosure below, the term “target” is to be widely construed to refer to any part, component, system, environment or other entity or entity collection, which is monitored by an image capture device. The device or system encompassing the target or its environment is referred to as “system”.

One technical problem dealt with by the disclosed subject matter is that while monitoring a target, changes may occur to the target, to the system or to the target environment, which may badly affect the images captured by the image capture device. The degradation of the images quality or usefulness may result from changes in the target, in the environment, in the image capturing timing relative to motion of the target, or the like, which results in lower quality or less informative images.

The degraded quality or reduced usefulness may make the images unusable for their intended usage, as the state of the target, a failure, an anomaly, or a change relative to previous images may not be sufficiently captured or detectable in the image.

The degraded quality or reduced usefulness may occur due to a plurality of factors.

One such factor may be that the target, alone or as part of the system or the environment, is subject to motion caused by vibration of the system or its vicinity. In some situations, for example when the vibration is unexpected, the vibration may cause the images to become blurred, or the target not to be captured by the image as intended. In other situations, where the vibration is expected and is for example periodic, the image capturing may not be synchronized with the vibration period, or operate with suboptimal parameters such as shutter speed, and thus not represent the target at the desired location or state.

Other factors that may affect the image quality may include movement of the target, or changing environmental parameters such as light, temperature, humidity, fog, smoke, or others. Such factors may or may not occur due to motions, whether linear, circular, or having any other shape in one or more dimensions. One type of such motions is cyclic motions which may refer to a repetitive motion with detectable start and stop points occurring generally at low frequency and large amplitude. Other type of motions are vibrations which describe rapid oscillations occurring at high frequency and small amplitude, often in multiple directions. However, the term vibrations may also refer to unexpected, changing, or erratic movements. Unless specifically noted otherwise, the terms “vibration”, “motion” and “cyclic motion” are used interchangeably in this disclosure and are to be widely construed to cover all such movements.

In some examples, such motions may have an effect on various parameters, such as temperature or light, due to movement of the target among different heat zones of the system.

Thus, in order to improve the image characteristics such that the captured images may be used for monitoring the target, it is required to adapt to the vibrations, other movements, or changes in the target or in the system.

One technical solution of the disclosed subject matter relates to setting or updating the settings of the image capture device according to the changing parameters of the target or system.

The technical solution may be obtained by providing one or more sensors for sensing parameters of the imaged scene, which are optionally located externally to the image capture device. For example, one or more sensors may be located on the target, in the vicinity of the target, within or in the vicinity of the system, or the like. The output provided by the sensors may be processed and used for determining one or more settings or changes to such settings of the image capture device. The settings and/or changes may then be applied, and the image capture device may continue capturing images with the new settings, such that the images depict the target and can be used for analyzing its state for monitoring the target's state or health and maintenance of the target or the system it is part of.

The sensors may be located in a reachable location which is indicative of the parameters, such as but not limited to on or in the vicinity of the target, on or in the vicinity of the system. However, the one or more of the sensors may also be located in locations of the target, the system, or its vicinity which are hard or dangerous to reach, for example in locations that require dismantling of parts of the system in order to position the sensors, narrow cavities, near powerful engines, or the like. In addition, one or more sensors may be positioned in locations with harsh environments, for example in environments which reach extreme temperatures, humidity levels, shocks and/or altitude during operation of the system.

The sensors may include but are not limited to any one or more of the following sensors:
A vibration sensor, which may output a vibration frequency of an imaged object;
A microphone for detecting sound reverberation and patterns associated with movement of an object, wherein the microphone can receive audio in one or more frequencies;
A temperature sensor which may monitor temperature variations, to detect periodical movement in different heat zones of the system;
A proximity sensor that determines distance of an object to the target;
A speedometer which may measure movement speed of an object;
A humidity or dirt sensor for detecting humidity, liquid spray, dust or dirt in the system;
A smoke, fog or water spray sensors;
An altitude sensor for detecting the altitude of the target;
A rotation sensor for detecting rotation of the target (e.g., to detect rotation of an aerial vehicle in the pitch and/or yaw and/or roll directions); and
A light meter which may detect light reflections from a moving element.

The output of the sensors may be used for determining characteristics of the motion of the monitored target. For example, if the target moves in a cyclic manner, the frequency of the motion, the amplitude in case of linear motion, and/or one or more points to be reached at particular points in time during the motion, may be determined from the sensors'output. Changes in one or more of the following settings or operation parameters of the image capture device may be determined upon the readings or the motion pattern. It is appreciated that changes to settings other than the ones below may also be determined as well.
Imaging frame rate, such that the target is imaged at the required frequency(ies) over the vibration cycle. This setting may be affected by output from a vibration sensor, a microphone, a temperature sensor, or a proximity sensor.
Imaging timing, to ensure that an image is captured at the required timing during the cycle, for example when the target is at a required position. This setting may be affected by output from a location sensor, a vibration sensor, a microphone, a temperature sensor, or a proximity sensor.
Shutter speed, to ensure that the captured images are sharp and not blurred due to motion of the target. This setting may be affected by output from a light meter, a vibration sensor, a microphone, a proximity sensor, or a speedometer.
Lighting, to ensure that the target is captured with an adequate amount of light such that the image is clear and can be processed. Changing the lighting settings may be triggered by output of a light sensor or of a smoke/fog sensor for example. By modifying the light intensity or direction, the glare may be reduced and the image clarity may be improved. It is appreciated that the lighting settings may also be coupled with the shutter speed.
Triggering the closure of a mechanical shutter on the image capture device, to protect the lens from dirt and ensure consistent image quality, as may be triggered by a humidity or dirt sensor.
Triggering the closure of a mechanical shutter on the image capture device when there is no need to perform image capture.
Controlling the image capture device to initiate and/or terminate image capture.

One technical effect of the disclosure may relate to controlling the configuration and/or operating parameters of an image capture device based on data obtained from the external sensors. Examples of operating parameters which may be controlled include but are not limited to: shutter speed, field of view, zoom, focus and other mechanical and/or electro-optical parameters.

Another technical effect of the disclosure may relate to the possibility of installing the sensors at places that are hard to reach during normal operation of the monitored system. For example, the sensors may be installed as part of constructing the system when the locations are still accessible. Then, when the system is operative, access is gained to data gathered from locations, which may otherwise be impossible to access without dismantling system parts. The displacement of the sensor from the image capture device provides for obtaining data that is more accurate and relevant than what can be obtained at the vicinity of the capture device, or the like.

Yet another technical effect of the disclosure relates to adapting the images captured by the image capture device to the changing state and conditions of the target, the system or the environment. For example, by changing the image capture device's imaging frequency, timing, and shutter speed, the image capture device may be synchronized with vibrations and or cyclic movements applied to the target, such that the images are taken at sync with the vibration and at the right timing.

Moreover, synchronizing the capturing of images with the vibration and or cyclic movements of the images object may provide for covering the entire range of movement. For example, when the target is a helicopter rotor, by synchronizing the capture rate with the rotation frequency, and capturing a sufficient number of images, it may be ensured that every blade of the rotor is monitored, to ensure proper coverage and problem detection, which may be utilized for preventive maintenance.

In addition, synchronizing the capturing of images with the vibration and or cyclic movements of the images object may provide for imaging the target at the same position. For example, when the target is a vibrating mechanism, by synchronizing the camera settings with the vibrations, it may be ensured that the mechanism is imaged at a fixed position within the cycle, which may enable comparison of the different images over time at the same position.

Yet another technical effect of the disclosure may relate to a target moving in a cyclic motion (i.e. linear or rotational), wherein using a position sensor to monitor position of the target object may enable timing the capturing of images to when the target is at the displacement end(s). This may provide for determining the target's amplitude which may be used for identifying anomalies in its motion.

Yet another technical effect of the disclosure may relate to adjusting the capture device's shutter speed, gain, illumination provided by or in coordination with the image capture system (e.g., light strobe's pulse duration, direction or intensity) based on the target's light conditions (which may be determined, for example, from readings obtained from a light meter). The adjusting may be advantageous in complying with changing light conditions as may be determined from light, smoke, fog or water spray sensors, to ensure informative images having sufficient clarity for processing.

Yet another technical effect of the disclosure relates to using output from humidity, liquid spray, dust or dirt sensors for triggering the closure of a mechanical shutter on the camera to protect the lens from dirt and ensure consistent image quality.

Yet another technical effect of the disclosure may relate to improving the quality and usability of monitoring images, without having to analyze the captured images. Analyzing data from sensors instead of processing images may save significant time and thus provide for faster response, and may also save significant computing resources including memory and energy, thus also avoiding heating.

Yet another technical effect of the disclosure may relate to selecting or adapting the method (e.g., whether and which algorithm to be) used to process the captured images based on the data from the sensors, in order to improve the analysis results. This may reduce or eliminate incorrect or unneeded analysis of the captured images. For example, if the target is located in an aircraft, data from a rotation sensor may indicate that the aircraft is flying at an angle (e.g. during takeoff or landing). This angle may be compensated for during the image analysis. In a further example, the target is a liquid container in the aircraft and the image analysis is performed to determine how much liquid is present in the container. Analyzing the images while the liquid container is at an angle may result in incorrect results. In this case, analysis might not be performed on images collected while the aircraft is flying at an angle, or the image analysis algorithm may be adapted to take the aircraft flying angle into account.

Yet another technical effect of the disclosure may relate to capturing images only under certain conditions, which are determined based on the data from the sensors. This reduces unnecessary usage of processing resources and/or memory. For example, if the target is a component of an aircraft, an altitude sensor may indicate the altitude of the aircraft. The image capture device may be controlled to capture images only while the aircraft is at certain altitudes (e.g. only during flight or only on the ground).

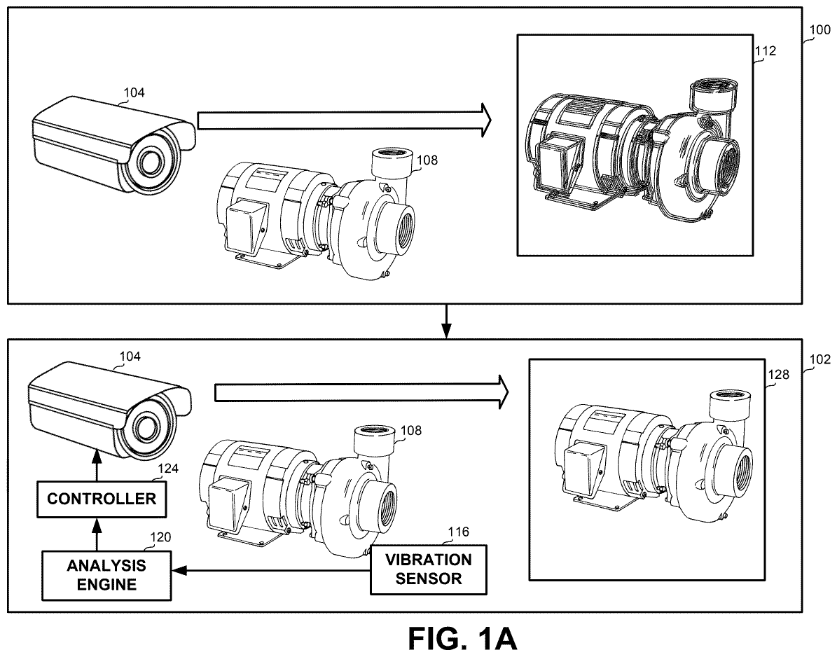

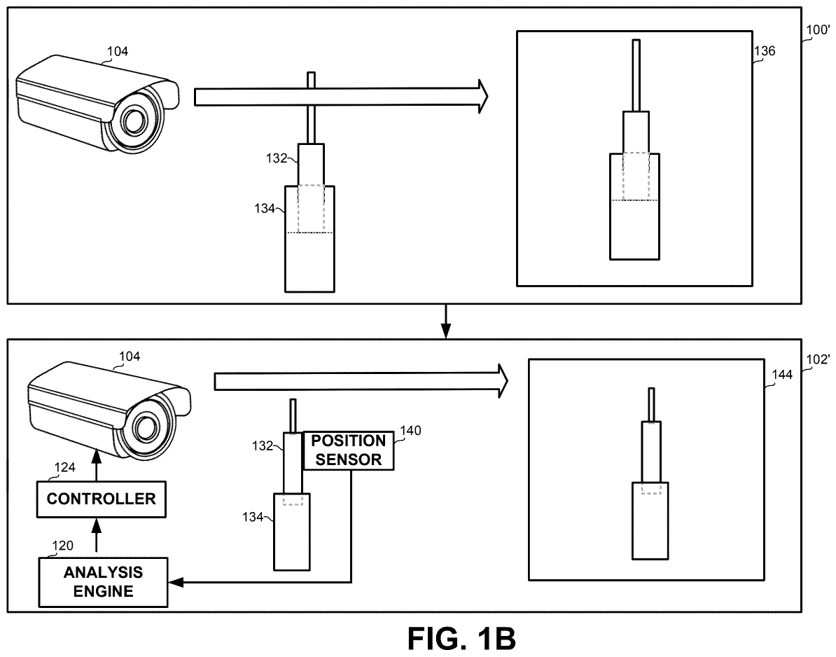

Referring now to FIG. 1A and FIG. 1B, showing schematic illustrations of exemplary monitoring environments, in accordance with some exemplary embodiments of the disclosure.

FIG. 1A shows pane 100 where the disclosure is not used, and pane 102 where the disclosure is used.

Pane 100 shows image capture device 104, which may be a still camera, a video camera, a thermal camera, or the like, which produces frames that can be represented graphically, of a monitored target.

The target may be any object, such as pump 108, which may be subject to vibrations, whether generated by the operation of the pump, or due to another reason such as the vibrations of the system, vibrations of the platform the system is installed on, or of another nearby vibrating object.

Image capture device 104 captures images of pump 108, for example for monitoring purposes, possibly as part of monitoring a larger system.

Due to the vibrations pump 108 is experiencing, the frames, such as exemplary frame 112, are blurred. Therefore, frame 112 cannot be analyzed to efficiently learn about the health of pump 108. For example, cracks can go unnoticed, components can unscrew, or the like, without the option to identify such condition from the images due to the smearing.

In some exemplary embodiments, as shown in pane 102, a vibration sensor 116 may be used. Vibration sensor 116 may be installed in contact with pump 108, in the vicinity of pump 108, or at any other location that is subject to or affected by the same vibrations as pump 108, or from which the vibrations can be determined.

The output of vibration sensor 108, expressed for example as an AC signal, may be provided to analysis engine 120.

Analysis engine 120, which may be implemented as a software component, a hardware component, a firmware component, a combination of two or more of the above, or the like, may be configured to receive the AC signal as output from vibration sensor 108, and analyze the signal frequency. Analysis engine 120 may then send one or more instructions to controller 124 to set or change settings of capture device 104. The settings may first include synching the frequency at which image capture device 104 is capturing images of pump 108. Thus, the images are always taken at the same timing(s) within the vibration cycle, and therefore represent pump 108 at the same states. The consistency of the images enables comparing the images and identifying failures, problems, or the like.

Alternatively or additionally, the settings may further comprise timing the shutter speed and/or adjusting the lighting of image capture device 104, such that the images are sharp and enable the detection of small details such as cracks, misalignments, or the like.

Referring now to FIG. 1B, showing a schematic illustration of another exemplary monitoring environment, in accordance with some exemplary embodiments of the disclosure.

Pane 100′, as pane 100 above, shows image capture device 104 and a target, being a piston 132 which is subject to linear movement relative to cylinder 134.

Image capture device 104 may capture images of piston 132, for example for monitoring purposes, possibly as part of monitoring a larger system.

Due to the linear movement of piston 132, the frames, such as exemplary frame 136, capture piston 132 at a certain point along its linear movement relative to cylinder 134. Therefore, it cannot be figured out from frame 136 whether piston 132 covers its full trajectory or not, and it may be impossible to take images at specific points of the piston movements.

In some exemplary embodiments, as shown in pane 102′, a position sensor 140 may be used. Position sensor 140 may detect the position of piston 132, for example the position of its topmost end. Position sensor 140 may indicate the absolute location of piston 132 or its location relative to cylinder 134. Position sensor 140 may be installed in contact with piston 132, at a location where piston 132 is supposed to reach, on cylinder 134, in the vicinity of piston 132, or the like.

The output of position sensor 140, expressed for example as a series of distances or locations of piston 132 from position sensor 140, may be provided to analysis engine 120.

Analysis engine 120 may be configured to receive and analyze the output of position sensor 140. Thus, in some exemplary embodiments, analysis engine 120 may be configured to receive a series of readings and determine upon the readings the frequency, amplitude, and/or other characteristics of the motion of piston 132. Analysis engine 120 may then make sure that the images of piston 132 are taken when piston 132 for example is supposed to reach one or more desired points, such as the endpoints of its intended trajectory or other predefined positions. Analysis engine 120 may thus send one or more instructions directly to image capture device 104 or through controller 124 to adjust the parameters of image capture device 104 to synchronize with the periodic motion, allowing it to capture images of piston 132 at one or more predefined points, such as the start, end, or somewhere in the middle of the stroke. By taking the images at the same time during the cycle, it is ensured that the images are consistent with each other. Moreover, if piston 132 does not reach its intended end location(s) or other predefined position(s), it may be reflected by images not being taken, or by images depicting piston 132 in a wrong location and thus different from previously captured images.

It is appreciated that defining the settings of capture device 104 may further comprise setting its shutter speed and/or lighting such that the images are sharp and enable the detection of small details or failures in piston 132, such as cracks, misalignments, or the like.

It is appreciated that the environments shown in FIG. 1A and FIG. 1B are exemplary only, and multiple other examples may be provided for using output from one or more external sensors of various types, for improving the quality and usability of captured images used for monitoring targets.

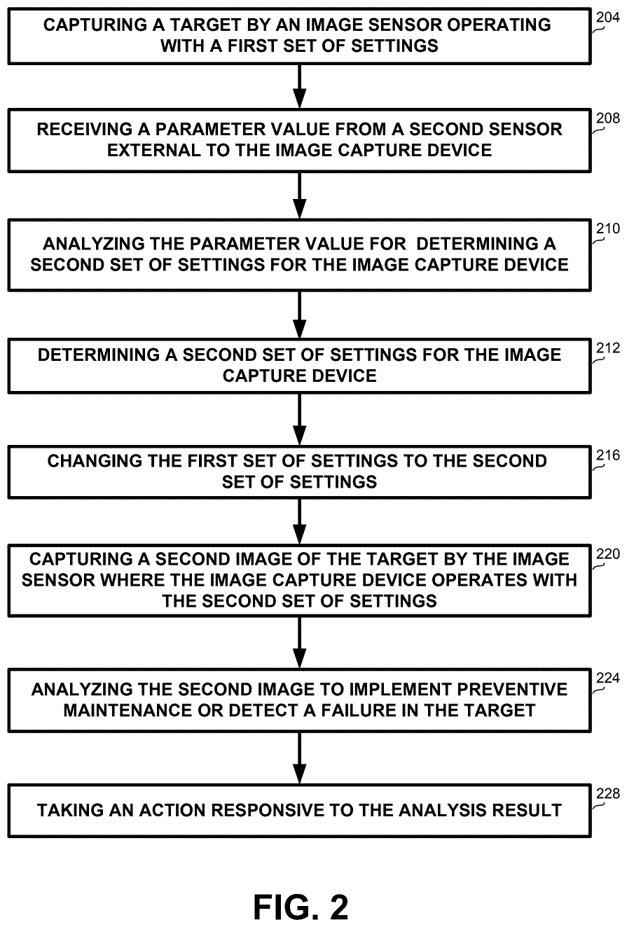

Referring now to FIG. 2, showing a flowchart of steps in a method for monitoring a target, in accordance with some exemplary embodiments of the disclosure.

At step 204, a target may be captured by an image sensor of an image capture device as part of a periodic check, preventive maintenance or any other purpose. The image sensor may be operating with a first set of settings, such as capturing frequency and timing, shutter speed, or the like. In some embodiments, step 204 is not performed and parameters of the target are first received to initially set the image capture device as in steps 208-212.

At step 208, a value or set of values, such as a signal, of a parameter may be received from one or more second sensors, optionally external to the image capture device. In accordance with the target and the second sensor type, the second sensor may be embedded within the target, positioned adjacent to the target, positioned at a location where the sensed parameter is indicative of the conditions of the target, or the like.

For example, the sensor may be a non-optical sensor, such as vibration sensor, a position sensor, a speedometer, an accelerometer, a microphone, a temperature sensor, a proximity sensor, or the like. In further embodiments, the sensor may provide an optical-related indication, for example a light meter adapted to detect light intensity, light intensity in one or more wave lengths, or the like.

At step 210, the parameter value or set of values may be analyzed for determining characteristics of a cyclic motion of the target, if the target indeed moves in a cyclic manner. For example, the frequency of the motion may be determined by the time lapse between two images depicting the target in the same location and direction. Additionally or alternatively, the amplitude of the motion, one or more points to be reached during the motion, or other characteristics of the motion may be determined from the readings. In some embodiments, the parameter value may be compared to previously obtained values of the parameter. In further embodiments, the parameter value or set of values may be analyzed for a different purpose, such as the angle of the monitored system, the altitude, or the like.

At step 212, a second set of settings may be determined, to be applied to the image capture device, upon the received parameter values and/or upon the characteristics of the motion or system as determined at step 210, such that the images will be clear and also indicative of the state of the target. In some embodiments, the second set may be determined upon a significant change between the received parameters and/or determined characteristics, and previous values thereof, for example a difference exceeding a threshold in accordance with a corresponding metric.

In some embodiments, the analysis of steps 210 and/or 212 may be performed by a rule engine adapted to output a set of settings in response to received values. In some embodiments, an artificial intelligence (AI) engine, such as a neural network, may be trained to output a set of settings corresponding to the parameter value. In further embodiments, a human user may adjust the settings manually upon receiving output from the analysis engine.

For example, the frequency of capturing images may be synchronized with a vibration or cyclic motion frequency of the target as determined by a vibration sensor. Additionally, the capture timing(s) within the cycle may be determined in accordance with the output received from a position sensor, such that the images capture the target at the right time. In other examples, capturing multiple frames during each vibration cycle may provide for capturing all the relevant views or components of the target.

In further examples, the capturing settings may be adjusted, such as shutter speed, gain, light, or the like, which may provide for images of clarity and quality that is sufficient for processing and detecting problems or failures.

In further examples, the capturing device may be configured not to take images for a predetermined period of time or until further instruction, as the conditions may not be representative or adequate for image analysis, such as flying at certain angles.

In another example, the image capture device may be triggered to close a mechanical shutter to protect the lens from dirt and ensure consistent image quality in response to output from humidity, liquid spray, dust or dirt sensor.

In further examples, the lighting duration, intensity and direction may be adjusted in accordance with output from a smoke, fog or spray sensor, to ensure adequate light level for the images.

At step 216, the settings of the image capture device may be changed from the first set of settings, in accordance with the settings determined at step 212. The settings may be adjusted by a controller upon receiving instructions from a processor analyzing the parameter values.

At step 220 the image capture device may capture at least one second image, using the newly adjusted set of settings.

At step 224, the at least one second image or set of images may be analyzed. The images may be analyzed by comparing one or more images to previously captured images, to identify changes such as cracks, chips or other structural changes, mold, rust, or the like. In some embodiments one or more images may be analyzed on their own to detect problems, failures, or the like.

In some embodiments, the analysis may be changed or omitted in response to the parameters. For example, if the system is at an angle, the liquid volume may not be analyzed correctly, therefore it may be analyzed by taking into account the angle, or by omitting the calculation until the angle is acceptable for such calculation.

The ongoing monitoring, enabling for detecting changes or problems, may be used for health monitoring, preventive maintenance of the system, early detection and fixing of problems, or the like.

Thus, at step 228, an action may be taken in response to and in order to utilize the analysis results. For example, the action may include providing an alert message to a user such as a person in charge, in the form of an electronic message such as a short message or an e-mail, or the like, updating a database, activating an audio or visual alert, or the like. Further actions may include but are not limited to recommending a maintenance activity, sending maintenance instructions, indicating a predicted time to failure, or the like.

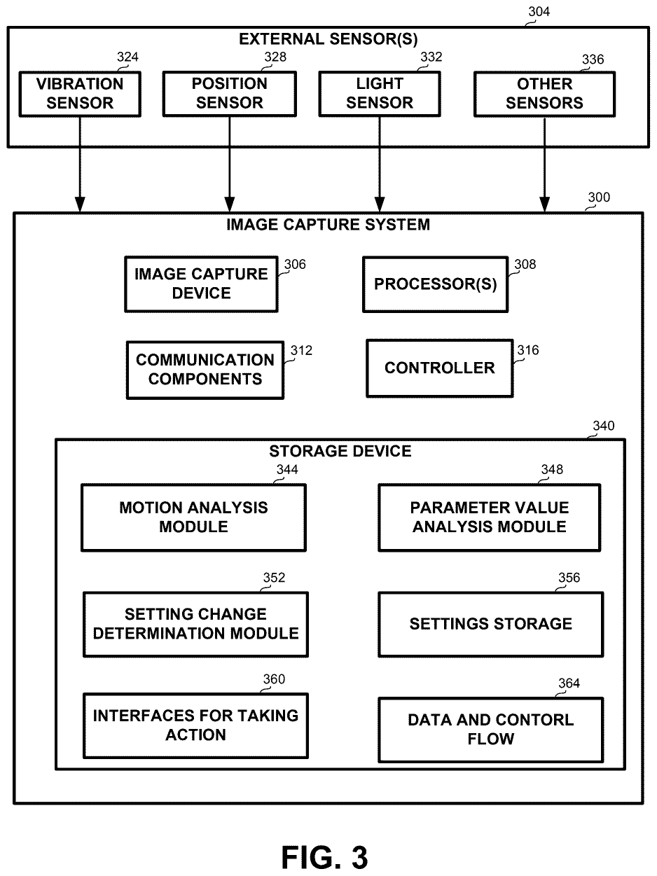

Referring now to FIG. 3, showing a schematic block diagram of a system for monitoring a target, in accordance with some exemplary embodiments of the disclosure.

The image capture system, generally referenced 300 comprises an image capture device 306, a processor 308, a communication components(s) 312 and a controller 316.

The environment may comprise one or more external sensors 304, which may be in direct or indirect communication with image capture system 300. External sensors 304 may include but are not limited to any one or more of the following: vibration sensor 324, position sensor 328, light sensor 332 which may relate to the total amount of light or to the amount light in a certain spectrum, or any other sensor(s) 336. Sensors 336 may comprise one or more of: speedometer, humidity sensor, temperature sensors, microphones, proximity sensor, altitude sensor, angle sensor, or other types of sensors.

Image capture device 306 may be designed to capture images, whether still images, video frames, thermal images, or the like, which may provide a visual representation of a target.

Processor 308 may be configured for analyzing data related to the target, determining settings for image capture device 306, and providing corresponding instructions to controller 316.

Processor 308 may be an Application Processor, a Central Processing Unit (CPU), Application Specific Integrated Circuit (ASIC), a microprocessor, an Integrated Circuit (IC) or the like. Alternatively, processor 308 can be implemented as firmware written for or ported to a specific processor such as digital signal processor (DSP) or microcontrollers, or can be implemented as hardware or configurable hardware such as field programmable gate array (FPGA).

Communication components 312 may be configured to communicate with other devices, such as external sensors, other computing platforms, or the like. Communication components 312 may be capable of communicating via any wired or wireless communication channel using any corresponding communication protocol.

Controllers 316 may be configured to adjust image capture device 306, for example change the settings of image capture device 306 such as the shutter speed, illumination, triggering image capture device 306 to capture an image, or the like.

In some exemplary embodiments, system 300 may comprise storage device 340. Storage device 340 may be a hard disk drive, a Flash disk, a Random Access Memory (RAM), a memory chip, or the like. In some exemplary embodiments, storage device 340 may retain program code operative to cause processor 308 to perform acts associated with any of the subcomponents of system 300, and steps associated with FIG. 2 above.

The components detailed below may be implemented as one or more sets of interrelated computer instructions, executed for example by processor 308 or by another processor. The components may be arranged as one or more executable files, dynamic libraries, static libraries, methods, functions, services, or the like, programmed in any programming language and under any computing environment.

Storage device 340 may retain motion analysis module 344, for analyzing output received from any one or more of external sensors 304. In some embodiments, analysis may include determining characteristics of a cyclic motion of the target, such as vibration cycle length to which the target is subject (e.g., frequency and/or amplitude), or the like. The motion may be analyzed from a proximity sensor, a vibration sensor, a temperature sensor, a light sensor, a combination of two or more of the above, and/or additional sensors.

In some embodiments, analysis may include integrating the data from external sensors 304 with data from other sources, such as sensors within image capture device 306, the Internet, or the like.

Storage device 340 may retain parameter value analysis module 348, for receiving the motion analysis results, and determining parameters, settings or configuration for the image capture device, such as triggering times. Optionally, parameter value analysis module 348 may integrate the data from external sensors 304 with data from other sources, such as sensors within image capture device 306, the Internet, or the like. Analysis may further include analyzing additional parameters, such as the available amount of light, or the like.

Analysis may further include comparing the parameters or the analysis results to previously available values, and determining whether the differences are significant enough to justify changing the capturing parameters, for example, whether the differences exceed a predetermined threshold.

Storage device 340 may retain setting change determination module 352, for determining changes to be applied to image capture device 306, such as the triggering capture times within a cycle, setting the shutter speed, or the like. In some embodiments, parameter value analysis module 348 and setting change determination module 352 may be implemented in a unified module.

Storage device 340 may retain setting storage 356, for storing current and optionally historical settings of image capture device 306, sets of settings adapted for certain situations, thresholds, or the like.

Storage device 340 may retain one or more interfaces 360 for initiating or taking actions responsive to the analysis results and optionally to additional data, such as baseline parameters, operational parameters, environmental parameters or the like. For example, interfaces 360 may comprise one or more interfaces for sending messages to users, updating a database, or the like.

Storage device 340 may retain data and control flow 364 for activating the various modules at the right time with the required input.

Flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a solid state memory, a hard disk, a random access memory (RAM), a read-only memory (ROM), an erasable programmable read-only memory (EPROM or Flash memory), a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, C#, C++ or the like and conventional procedural programming languages, such as the “C”, assembly programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), a wired network, a wireless network, a combination thereof, or the like.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for monitoring a target, the method comprising:
receiving from a non-optical sensor external to an image capture device capturing the target or a part thereof, an indication to a value of a parameter of the target or an environment of the target;
determining a set of settings for the image capture device in accordance with the value of the parameter; and
capturing an image of the target by the image capture device using the set of settings.

2. The method of claim 1, further comprising analyzing from the indication at least one characteristic of a cyclic motion of the target.

3. The method of claim 2, wherein determining the set of settings is based on at least one of a frequency or an amplitude of the cyclic motion.

4. The method of claim 1, further comprising:
capturing a first image of the target by the image capture device embedded within an image capture system, the image capture device operating with a first set of settings, the target being subject to a first set of values corresponding to a set of parameters;
upon the value of the received parameter or a result of processing thereof being different in at least a predetermined threshold from a previous value, changing the first set of settings of the image capture device to the second set of settings; and
capturing a second image of the target by the image capture device wherein the image capture device operates under the second set of settings.

5. The method of claim 4, further comprising analyzing the second image to obtain an analysis of the target.

6. The method of claim 5, wherein a method used to analyze the second image is based on the indication provided by the sensor external to an image capture device.

7. The method of claim 5, further comprising using results of the analysis for detecting a failure or a required preventive maintenance action of the target or of a second system the target is a part of.

8. The method of claim 5, further comprising taking an action in response to determining the set of settings, or to detecting a failure or a required preventive maintenance action, wherein the action comprises at least one item selected from the group consisting of: sending a message or an e-mail to a user, recommending a maintenance activity, providing maintenance instruction, activating an audio or visual alert, and indicating a predicted time to failure.

9. The method of claim 1, wherein the settings comprise frame rate or shutter speed.

10. The method of claim 1, wherein the second sensor comprises at least one sensor selected from the group consisting of: a vibration sensor, a motion sensor, a position sensor, a proximity sensor, a speedometer, a microphone, a temperature sensor; a humidity sensor; an altitude sensor, a rotation sensor, and a touch sensor.

11. The method of claim 1, wherein the parameter comprises at least one item selected from the group consisting of: target vibration, target speed, target proximity from the second sensor, target position, audio level in one or more frequencies, another audio characteristic, temperature, humidity, target altitude, target flight angle and touch.

12. An image capture system for monitoring a target, comprising:
an image capture device;
a sensor external to an image capture device; and
a processor,
wherein the system is configured to:
receive by the processor from the sensor an indication to a value of a non-optical parameter from a set of parameters, of the target or an environment of the target;
determine by the processor a set of settings for the image capture device, in accordance with the value of the parameter; and
capture an image of the target by the image capture device using the set of settings.

13. The image capture system of claim 12, wherein the processor is further configured for analyzing from the indication at least one characteristic of a cyclic motion of the target, and
wherein determining the set of settings is based on at least one of a frequency or an amplitude of the cyclic motion.

14. The image capture system of claim 12, wherein the processor is further configured for:
capturing a first image of the target by the image capture device embedded within an image capture system, the image capture device operating with a first set of settings, the target being subject to a first set of values corresponding to a set of parameters;
upon the value of the received parameter or a result of processing thereof being different in at least a predetermined threshold from a previous value, changing the first set of settings of the image capture device to the second set of settings; and
capturing a second image of the target by the image capture device wherein the image capture device operates under the second set of settings.

15. The image capture system of claim 14, wherein the processor is further configured for:
analyzing the second image to obtain an analysis of the target; and
using results of the analysis for detecting a failure or a required preventive maintenance action of the target or of a second system the target is a part of.

16. The image capture system of claim 15, wherein the processor is further configured for taking an action in response to determining the set of settings, or to detecting the failure or the required preventive maintenance action, wherein the action comprises at least one item selected from the group consisting of: sending a short message or an e-mail to a user, recommending a maintenance activity, providing maintenance instruction, activating an audio or visual alert, and indicating a predicted time to failure.

17. The image capture system of claim 16, further comprising an interface for initiating taking the action.

18. The image capture system of claim 12, wherein the image capture device is one of a group consisting of: a video camera, a still camera and a thermal camera.

19. The image capture system of claim 12, wherein the settings comprise frame rate or shutter speed.

20. The image capture system of claim 12, wherein the second sensor comprises at least one sensor selected from the group consisting of: a vibration sensor, a motion sensor, a position sensor, a proximity sensor, a speedometer, a microphone, a temperature sensor; a humidity sensor; an altitude sensor, a rotation sensor, and a touch sensor.

21. The image capture system of claim 12, wherein the parameter comprises at least one item selected from the group consisting of: target vibration, target speed, target proximity from the second sensor, target position, audio level in one or more frequencies, another audio characteristic, temperature, humidity, and touch.
